(19) United States
(12) Patent Application Publication
(10) Pub. No.: US 2025/0163984 A1
(43) Pub. Date: May 22, 2025

(54) GAS PRESSURE SPRING WITH TEMPERATURE COMPENSATION, AND METHOD FOR PRODUCING THE GAS PRESSURE SPRING

(71) Applicant: Stabilus GmbH, Koblenz (DE)

(72) Inventors: Ulrich PROBST, Hillscheid (DE); Alexander REISER, Münstermaifeld (DE); Felix BEIB, Koblenz (DE); Nico UNKELBACH, Rüscheid (DE)

(21) Appl. No.: 18/842,287

(22) PCT Filed: Mar. 2, 2023
(86) PCT No.: PCT/EP2023/055351

§ 371 Date: Aug. 28, 2024

(30) Foreign Application Priority Data
Mar. 3, 2022 (DE) 10 2022 104 997.3

(51) Int. Cl. F16F 9/02; F16F 9/36; F16F 9/52

(52) U.S. Cl. CPC F16F 9/0209; F16F 9/368; F16F 9/526

(57) ABSTRACT

The invention relates to a gas pressure spring (50) comprising a working piston (2) which is guided displaceably in a working cylinder (1) along a stroke axis (H), a compensating cylinder (12) which encloses the working cylinder (1), and a compensating piston (10) which is of hollow-cylindrical shape and is guided displaceably in the compensating cylinder (12) along the stroke axis (H). The working cylinder (1) has an open end (1b), at which the compensating cylinder (12) forms a projection (15) beyond the working cylinder (1) with a closed end (15b). The compensating piston (10) separates a working chamber (1a) which is arranged in the working cylinder (1), a compensation chamber (12a) which is arranged between the working cylinder (1) and the compensating cylinder (12), and a restoring chamber (15a) arranged in the projection (15) from one another and is open at an upper side (10a) of the balancing piston (10) facing the working chamber (1a). The gas spring (50) comprises a seal (8) arranged on the upper side (10a) of the balance piston (10) which seals the balance piston (10) to the working cylinder (1) and to the balance cylinder (12).

### TECHNICAL FIELD

The invention relates to a gas pressure spring according to the preamble of claim 1 and a method for producing the gas pressure spring.

### PRIOR ART

Gas pressure springs are known from the state of the art in which a temperature dependence of the spring force is to be compensated by a compensating medium.

The publication EP 1 795 777 A2 describes a gas spring with a working cylinder in which a working piston is movably guided. The annular space formed between the working cylinder and a compensating cylinder is filled with a compensating medium that expands when the temperature increases. The open end of the working cylinder opposite the piston outlet end is closed by a pot-shaped compensating piston. When the compensating medium expands, it moves the compensating piston so that the volume of the working cylinder increases.

The publication DE 31 41 295 A1 relates to a gas spring which consists of a container on the inner wall of which a piston connected to the piston rod slides. A space filled with expansion material is located between a container-fixed partition wall and a disc piston, wherein this disc piston represents a movable partition wall for the space filled with expansion material. The gas spring also comprises a working chamber with a pressurized gas filling. When the temperature increases, the expansion material expands and causes the disc piston to move further away from the container-fixed partition wall, thereby increasing the size of the working chamber.

Known gas springs with temperature compensation are usually complicated in design, require a significantly larger installation space than gas pressure springs without temperature compensation, or cannot compensate for the temperature dependence over the entire application-relevant temperature range.

### Technical Object

The object of the invention is to create an economical and simply constructed gas pressure spring and an economical and reliable method for its production, wherein the spring force of the gas pressure spring is independent of the temperature over a widest possible temperature range.

### Technical Solution

The present invention provides a gas pressure spring in accordance with claim 1, which achieves the technical object. The object is also achieved by a method for producing the gas pressure spring according to claim 13. Advantageous embodiments result from the dependent claims.

The gas pressure spring comprises a working piston which is movably guided in a working cylinder along a stroke axis over a stroke region. The working piston is preferably movable relative to the working cylinder along the stroke axis. The working cylinder is preferably hollow-cylindrical in shape and/or arranged coaxially to the stroke axis.

The gas pressure spring comprises a compensating cylinder enclosing the working cylinder radially to the stroke axis. The compensating cylinder is preferably hollow-cylindrical in shape and/or arranged coaxially to the stroke axis. The compensating cylinder is preferably rigidly attached to the working cylinder.

The gas pressure spring comprises a compensating piston hollow-cylindrical in shape which is movably guided in the compensating cylinder along the stroke axis. The compensating piston is preferably arranged coaxially to the stroke axis. The compensating piston is preferably movable relative to the compensating cylinder and to the working cylinder along the stroke axis.

The working cylinder has an open end along the stroke axis.

“Open” means at least that a gas can freely exit from the working cylinder and enter the working cylinder through the open end. Preferably the open end is completely open.

At a piston rod end of the working cylinder opposite the open end along the stroke axis, a piston rod attached to the working piston is preferably led out of the working cylinder through a sealing device. The sealing device preferably closes the piston rod end to a gas. “Closed” means that no gas can escape from or enter into the working cylinder at the piston rod end.

According to an embodiment of the working cylinder also advantageous for generic gas pressure springs independently of the other features of the invention, the working cylinder preferably has, in a sealing region between the stroke region and the piston rod end of the working cylinder at which the piston rod exits the working cylinder, a sealing region outer diameter measured radially to the stroke axis which is larger than the stroke region outer diameter of the working cylinder. The sealing region outer diameter is, for example, 18 mm to 21 mm and is preferably constant across the sealing region.

Due to the enlarged sealing region outer diameter, the sealing device can be arranged and held in the working cylinder, in particular completely in the working cylinder, even with a large diameter of the piston rod, for example, 10 mm. This means that no separate holding element is required to hold the sealing device. The holding element could, for example, be a sleeve, in particular an aluminum sleeve, inserted into the piston rod end of the working cylinder. Consequently, the gas spring is very easy and economical to manufacture.

The compensating cylinder forms a projection over the working cylinder at the open end with a closed end along the stroke axis.

At a piston rod end of the compensating cylinder opposite the closed end along the stroke axis, the piston rod of the gas pressure spring is preferably led out of the compensating cylinder through a sealing device. The sealing device preferably closes the piston rod end to a gas.

The compensating piston separates from each other a working chamber arranged in the working cylinder, a compensation chamber arranged between the working cylinder and the compensating cylinder, and a resetting chamber arranged preferably gas-tight in the projection.

The compensating piston preferably has a cylinder bottom on an underside of the compensating piston facing the resetting chamber. The cylinder bottom is preferably aligned perpendicular to the stroke axis and/or closed.

The compensating piston preferably comprises a cylinder jacket arranged sectionally between the working cylinder and the compensating cylinder. The cylinder jacket preferably runs around the stroke axis and/or is closed. An arrangement of the cylinder jacket sectionally between the working cylinder and the compensating cylinder has the advantage that the installation length of the gas pressure spring is reduced.

The compensating piston is open at an upper side of the compensating piston facing the working chamber. This results in the advantage that the interior of the compensating piston serves as part of the working chamber, so that the gas pressure spring is designed particularly compact.

The compensating piston is preferably pot-shaped, wherein the cylinder bottom corresponds to a pot bottom and the cylinder jacket corresponds to a pot wall.

A hollow cylindrical or pot-shaped compensating piston has the advantage that it can separate the working chamber, the compensation chamber and the resetting chamber with particularly low material requirements.

A compensating medium is preferably arranged in the compensation chamber, which moves the compensating piston towards the closed end when the compensating medium is heated.

The compensating medium preferably comprises an expansion material, in particular an expansion wax, particularly preferably a mixture of an expansion wax and an oil. The compensation medium can consist in particular of the expansion material, the expansion wax or the mixture of expansion wax and oil. The compensating medium can, for example, be designed like the compensating medium described in the document EP 1 795 777 A2. The expansion wax can, for example, be designed like the expansion wax described in the application DE 10 2020 113 749. The pressure of the compensation medium is, for example, from 70 bar to 350 bar.

A resetting means is preferably arranged in the resetting chamber, which displaces the compensating piston away from the closed end when the compensating medium cools down.

The resetting means preferably comprises or is a resetting gas, wherein the resetting gas is preferably the same gas that fills the working chamber as the working gas. The resetting gas and/or the working gas is, for example, nitrogen. The resetting means can comprise a mechanical resetting element, for example a spring, in particular a helical compression spring, or be formed therefrom.

The gas pressure of the working gas is, for example, from 20 bar to 250 bar. The gas pressure of the resetting gas is, for example, from 20 bar to 350 bar.

The gas pressure spring comprises a seal, in particular exactly one, arranged at, in particular on, the upper side of the compensating piston, preferably movable with the compensating piston along the stroke axis, which seals the compensating piston from the working cylinder and from the compensating cylinder, in particular seals it gas-tight.

In previously known gas pressure springs with temperature compensation, for example according to EP 1 795 777 A2, at least two seals are necessary to seal a compensating piston to a working cylinder and a compensating cylinder. The sealing of the working cylinder and compensating cylinder according to the invention with a single seal leads to a much simpler and more economical production of the gas pressure spring and reduces possible leak points so that reliable operation of the gas pressure spring over a long service life is possible.

In order for the seal to be able to seal both the working cylinder and the compensating cylinder, it must be located on the top side of the compensating cylinder. Based on the prior art, an arrangement of the seal on the upper side of the compensating piston does not appear to be promising because only a narrow contact surface is available on the open upper side to attach the seal to the compensating piston.

However, tests have surprisingly shown that it is not necessary to attach the seal to the compensating piston. In fact, during the operation of the gas spring, the seal is pressed strongly enough against the compensating piston by the pressure of the compensating medium so that it reliably fulfills its sealing function.

Advantageously, the seal is not attached to the compensating piston, in particular neither to the compensating piston nor to the compensating cylinder or the working cylinder. This allows the gas spring to be very easily and economically manufactured.

### DESCRIPTION OF THE TYPES OF EMBODIMENTS

The compensating piston is preferably sealed exclusively by the seal to the working cylinder and the compensating cylinder. The gas pressure spring therefore does not include any additional seals between the working cylinder, compensating piston and compensating cylinder and is therefore particularly simple in design. The seal is preferably in one piece.

The seal preferably comprises a sealing ring, for example an O-ring, running around the stroke axis. Particularly preferably, the seal is a sealing ring running around the stroke axis.

The seal preferably comprises a polyurethane and/or an acrylonitrile butadiene rubber or consists thereof. Acrylonitrile butadiene rubber has the special advantage that only low friction forces occur between the seal and the compensating cylinder.

The compensating piston is preferably in one piece and can be obtained, for example, by being formed from a compensating piston blank. A one-piece compensating piston has the advantages that the production of the gas spring is simplified, and that the compensating piston does not contain any connection points that could cause leaks.

The compensating piston preferably comprises aluminum or a plastic or is made of aluminum or a plastic. A particularly light and economical compensating piston can be manufactured from the stated materials. Due to the shape and arrangement of the compensating piston according to the invention, it is stable even when using the stated materials, despite the high pressures prevailing in the gas pressure spring.

The gas pressure spring preferably comprises a guide element which movably guides the compensating piston relative to the compensating cylinder along the stroke axis, wherein the guide element preferably comprises a guide sleeve arranged in the projection between the compensating cylinder and the compensating piston, in particular coaxially to the stroke axis. The guide element can be attached to the compensating piston or to the compensating cylinder. The guide element can, for example, be integral with the compensating piston or the compensating cylinder. The guide element can, for example, comprise a guide ring, in particular of plastic, which can be fastened to the compensating piston in particular with a locking connection. The guide element advantageously prevents tilting of the compensating piston relative to the working cylinder and the compensating cylinder. Tilting could impair the sealing function of the seal on the compensating piston.

The compensating piston preferably comprises a cylinder rim, preferably adjacent to the upper side, projecting radially to the stroke axis beyond the cylinder jacket, wherein the seal is arranged on the cylinder rim. The cylinder rim provides an enlarged contact area between the seal and the compensating piston, so that the seal fulfills its sealing function particularly reliably. In addition, the seal can be more reliably moved along the stroke axis together with the compensating piston and, if necessary, attached to the compensating piston.

Preferably, the cylinder rim projects radially outwards beyond the cylinder jacket. As a result, an intermediate space open to the resetting chamber between the cylinder jacket and the compensating cylinder is available to the resetting means, so that the resetting chamber is increased for a given installation length. Due to the lower pressure of the resetting means resulting therefrom, the gas spring is easier to seal. In order to prevent the compensating piston from jamming in the compensating cylinder despite the radially outwardly projecting cylinder rim, the gas pressure spring in this embodiment preferably comprises the previously described guide element.

The guide element is preferably attached to the compensating piston or designed integrally therewith so that the guide element and the cylinder rim do not interfere with each other.

A distance of the compensating cylinder from the working cylinder measured radially to the stroke axis is preferably greater in the stroke region than in an end region of the working cylinder located between the stroke region and the open end of the working cylinder.

The smaller distance in the end region results in a smaller cross-sectional area of the compensation chamber perpendicular to the stroke axis in the end region. As a result, for a given temperature increase, the compensating piston is displaced further towards the closed end of the compensating cylinder by an expansion of the compensating medium so that the working chamber is increased further, and a greater compensation of the temperature dependence of the spring force of the gas pressure spring takes place.

Since the distance in the stroke region of the working piston is not reduced, the compensation chamber can still accommodate a sufficient amount of compensation medium for effective temperature compensation.

For example, the distance in the end region is 10% to 50%, preferably 20% to 40%, particularly preferably 30% smaller than in the stroke region. The distance in the end region is, for example, 1 mm to 8 mm, preferably 2 mm to 4 mm, particularly preferably 2.5 mm. The distance in the stroke region is, for example, 2 mm to 12 mm, preferably 3 mm to 6 mm, particularly preferably 3 mm to 3.5 mm. With the stated values of the distance, a large, in particular complete, compensation of the temperature dependence of the spring force of the gas pressure spring can be achieved over a typical operating temperature range of the gas pressure spring, for example from −10° C. to +60° C.

Preferably, the distance of the compensating cylinder from the working cylinder in the end region and/or in the stroke region is independent of a position along the stroke axis. In this embodiment, the distance is constant in the end region and/or in the stroke region along the stroke axis, which makes the gas pressure spring very easy to manufacture.

An end region outer diameter of the working cylinder measured radially to the stroke axis is preferably larger in the end region of the working cylinder than a stroke region outer diameter of the working cylinder measured radially to the stroke axis in the stroke region. Such an expansion of the working cylinder in the end region results in a reduced distance between the working cylinder and the compensating cylinder without changing the compensating cylinder or the shape of the working cylinder in the stroke region. Accordingly, the reduced distance is achieved with as few changes as possible compared to a gas pressure spring from the prior art. The gas pressure spring can therefore be manufactured particularly easily and economically, especially using known components and methods.

The end region outer diameter of the working cylinder is preferably from 101% to 150%, preferably from 105% to 130%, particularly preferably from 110% to 120%, most preferably 112% to 113%, of the stroke region outer diameter of the working cylinder. The end region outer diameter is, for example, from 15 mm to 25 mm, preferably from 16 mm to 22 mm, particularly preferably from 18 mm to 21 mm. The stroke region outer diameter is, for example, from 10 mm to 20 mm, preferably from 15 mm to 19 mm, particularly preferably 17 mm to 18 mm. With the stated values of the outer diameters, a large-scale compensation of the temperature dependence of the spring force of the gas pressure spring can be achieved over a typical operating temperature range of the gas pressure spring.

Preferably, the outer diameter of the working cylinder in the end region and/or in the stroke region is independent of a position along the stroke axis. In this embodiment, the distance is constant in the end region and/or in the stroke region along the stroke axis, which makes the gas pressure spring very easy to manufacture.

A compensating cylinder inner diameter of the compensating cylinder measured radially to the stroke axis is preferably from 110% to 200%, preferably from 140% to 170%, particularly preferably from 150% to 160%, most preferably 155% to 157%, of the stroke region outer diameter of the working cylinder. The compensating cylinder inner diameter is, for example, from 20 mm to 30 mm, preferably from 23 mm to 27 mm, particularly preferably 25 mm. With the stated values of the compensating cylinder inner diameter, a large-scale compensation of the temperature dependence of the spring force of the gas pressure spring can be achieved over a typical operating temperature range of the gas pressure spring.

Preferably, the inner diameter of the compensating cylinder is independent from a position along the stroke axis. In this embodiment, the inner diameter of the compensating cylinder is constant along the stroke axis, which makes the gas pressure spring very easy to manufacture.

The stroke region and the end region of the working cylinder are preferably integrally connected to one another. The stroke region and the end region can, for example, be connected to one another with a material bond, in particular welded, soldered and/or glued to one another. The stroke region and the end region can, for example, be connected to one another in a form-fitting and/or force-fitting manner, in particular screwed, latched and/or clamped to one another.

The working cylinder can, for example, comprise or consist of a metal, in particular a steel, and/or a plastic.

A wall thickness of the working cylinder radially to the stroke axis is preferably substantially the same in the stroke region and in the end region of the working cylinder, in particular except for a reduction in the wall thickness caused by an expansion of the working cylinder in the end region, for example up to a reduction of up to 0.2 mm, and preferably independent of a position along the stroke axis. In this embodiment, the wall thickness of the working cylinder is constant along the stroke axis, which makes the gas pressure spring particularly easy to manufacture.

A wall thickness of the compensating cylinder radially to the stroke axis is preferably independent of a position along the stroke axis. In this embodiment, the wall thickness of the compensating cylinder is constant along the stroke axis, which makes the gas pressure spring particularly easy to manufacture.

The working cylinder and/or the compensating cylinder preferably comprises a non-homogeneously drawn tube, for example a tube with a weld seam along the stroke axis.

The method for producing the gas pressure spring comprises forming or machining a compensating piston blank into the compensating piston. The compensating piston can be manufactured, for example, by deep drawing a compensating piston blank of aluminum.

The method preferably comprises providing a working cylinder blank, preferably in the form of a non-homogeneously drawn tube, wherein the working cylinder blank is shaped as a hollow cylinder and has an outer diameter transverse to the longitudinal axis that is independent of a position along its longitudinal axis. The outer diameter is therefore constant along the stroke axis. The working cylinder blank can in particular be the working cylinder of a known gas pressure spring. The working cylinder blank preferably has material properties that depend on an azimuth with respect to its longitudinal axis, for example through a weld seam along the longitudinal axis. Such a working cylinder blank can be produced very easily and inexpensively, for example in that it is drawn from steel and welded.

The method preferably comprises forming the working cylinder blank into the working cylinder of the gas pressure spring, wherein the forming comprises widening the outer diameter of the working cylinder blank in at least one end region of the working cylinder blank.

The expansion preferably comprises inserting a mandrel into the at least one end region and preferably arranging a sleeve running around the longitudinal axis around the end region of the working cylinder blank before inserting the mandrel, so that the end region rests against the sleeve after the expansion. This advantageously allows the diameter of a working cylinder blank, whose material properties are dependent on an azimuth with respect to its longitudinal axis, to be expanded to a diameter independent of the azimuth.

### BRIEF DESCRIPTION OF THE DRAWINGS

FIG. 1 shows, by way of example, a schematic longitudinal section along the stroke axis of an embodiment of the gas pressure spring according to the invention.

FIG. 2 shows, by way of example, a schematic longitudinal section along the stroke axis of a further embodiment of the gas pressure spring according to the invention.

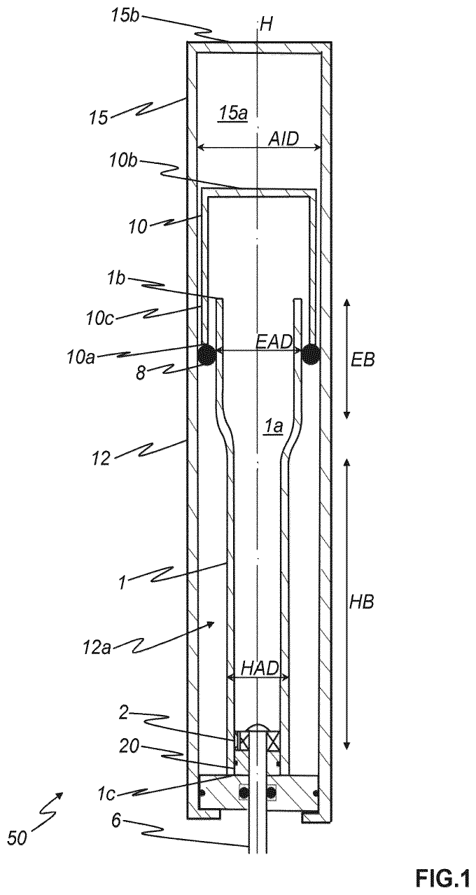

### FIG. 1

FIG. 1 shows a schematic longitudinal section along the drive axis A of a linear drive 50 according to the invention.

The shown gas pressure spring 50 comprises a working piston 2 which is movably guided in a working cylinder 1 along a stroke axis H over a stroke region HB, a compensating cylinder 12 surrounding the working cylinder 1 radially to the stroke axis H, and a compensating piston 10 movably guided in the compensating cylinder 12 along the stroke axis H relative to the working cylinder 1 and the compensating cylinder 12 and shaped like a hollow cylinder.

The working cylinder 1 has an open end 1b along the stroke axis H, wherein the compensating cylinder 12 at the open end 1b forms a projection 15 over the working cylinder 1 with a closed end 15b along the stroke axis H.

The compensating piston 10 separates from each other a working chamber 1a arranged in the working cylinder 1, a compensation chamber 12a arranged between the working cylinder 1 and the compensating cylinder 12 and a resetting chamber 15a arranged in the projection 15.

The compensating piston 10 comprises a cylinder bottom 10b and a cylinder jacket 10c arranged sectionally between the working cylinder 1 and the compensating cylinder 12 on an underside of the compensating piston 10 facing the resetting chamber 15a. The compensating piston 10 is open at an upper side 10a of the compensating piston 10 facing the working chamber 1a.

The gas pressure spring 50 comprises a seal 8 arranged on the upper side 10a of the compensating piston 10, for example a sealing ring concentric with the stroke axis H. The seal 8 seals the compensating piston 10 from the working cylinder 1 and from the compensating cylinder 12.

At a piston rod end 1c of the working cylinder 1 opposite the open end 1b along the stroke axis H, a piston rod 6 attached to the working piston 2 is preferably led out of the working cylinder 1 through a sealing device 20.

In the embodiment shown in FIG. 1, a distance of the compensating cylinder 12 from the working cylinder 1, measured radially to the stroke axis H, is greater in the stroke region HB than in an end region EB of the working cylinder 1 lying between the stroke region HB and the open end 1b of the working cylinder 1.

In this embodiment, the reduced distance in the end region EB comes about because an end region outer diameter EAD of the working cylinder 1 measured radially to the stroke axis H is larger than a stroke region outer diameter HAD of the working cylinder 1 in the stroke region HB measured radially to the stroke axis H. The end region outer diameter EAD is, for example, 18 mm to 21 mm and is preferably constant over the end region EB. The stroke region outer diameter HAD is, for example, 17 mm to 18 mm and is preferably constant over the stroke region HB.

A compensating cylinder inner diameter AID of the compensating cylinder 12 is, for example, 25 mm and is preferably constant along the stroke axis H.

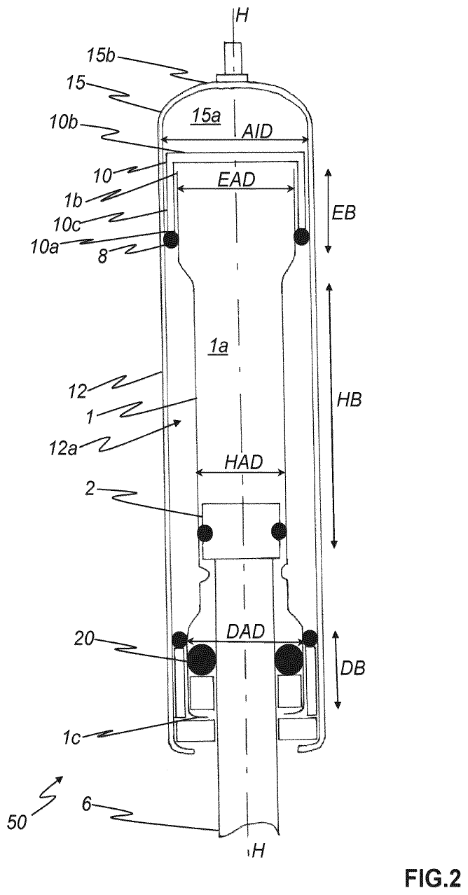

### FIG. 2

FIG. 2 shows a schematic longitudinal section along the stroke axis H of a further embodiment of the gas pressure spring 50 according to the invention.

The gas pressure spring 50 shown in FIG. 2 differs from the gas pressure spring 50 shown in FIG. 1 in that the working cylinder 1 has, in a sealing region DB between the stroke region HB and the piston rod end 1c of the working cylinder 1, at which the piston rod 6 exits the working cylinder 1, a sealing region outer diameter DAD measured radially to the stroke axis H, which is larger than the stroke region outer diameter HAD of the working cylinder 1. The sealing region outer diameter DAD is, for example, 18 mm to 21 mm and is preferably constant over the sealing region DB.

List of reference signs

| | | | |
|---|---|---|---|
| 1 | Working cylinder | 15 | Projection |
| 1a | Inner working | 15a | Resetting chamber |
| | chamber | | |
| 1b | Open end | 15b | Closed end |
| 1c | Piston rod end | 18 | Guide element |
| 2 | Working piston | 20 | Sealing device |
| 6 | Piston rod | 50 | Gas pressure spring |
| 8 | Seal | AID | Compensating cylinder inner diameter |
| 10 | Compensating | DAD | Sealing region outer diameter |
| | piston | | |
| 10a | Upper side | DB | Sealing region |
| 10b | Cylinder bottom | EAD | End region outer diameter |
| 10c | Cylinder jacket | EB | End region |
| 10d | Cylinder rim | H | Stroke axis |
| 12 | Compensating | HAD | Stroke region outer diameter |
| | cylinder | | |
| 12a | Compensation | HB | Stroke region |
| | chamber | | |

1. A gas pressure spring comprising:
a working piston movably guided in a working cylinder along a stroke axis over a stroke region;
a compensating cylinder enclosing the working cylinder radially to the stroke axis;
a compensating piston, hollow cylindrical in shape, which is movably guided in the compensating cylinder along the stroke axis,
wherein the working cylinder has an open end along the stroke axis,
wherein the compensating cylinder forms a projection over the working cylinder at the open end with a closed end along the stroke axis,
wherein the compensating piston
i. separates from each other in a gas-tight manner a working chamber arranged in the working cylinder, a compensation chamber arranged between the working cylinder and the compensation cylinder and a resetting chamber arranged in the projection, and
ii. is open at an upper side of the compensating piston facing the working chamber; and
a seal arranged on the upper side of the compensating piston, which seals the compensating piston from the working cylinder and from the compensating cylinder.

2. The gas pressure spring according to claim 1, wherein the compensating piston is sealed exclusively by the seal from the working cylinder and from the compensating cylinder.

3. The gas pressure spring according to claim 1, wherein the seal comprises a sealing ring running around the stroke axis.

4. The gas pressure spring according to claim 1, wherein the seal comprises a polyurethane and/or an acrylonitrile-butadiene rubber.

5. The gas pressure spring according to claim 1, wherein the compensating piston is in one piece.

6. The gas pressure spring according to claim 1, wherein the compensating piston comprises aluminum or a plastic.

7. The gas pressure spring according to claim 1, characterized by further comprising a guide element which movably guides the compensating piston relative to the compensating cylinder along the stroke axis, wherein the guide element preferably comprises a guide sleeve arranged in the projection between the compensating cylinder and the compensating piston.

8. The gas pressure spring according to claim 1,
wherein the compensating piston comprises a cylinder jacket arranged sectionally between the working cylinder and the compensating cylinder,
wherein the compensating piston comprises a cylinder rim adjacent to the upper side and projecting radially to the stroke axis beyond the cylinder jacket,
wherein the seal is arranged on the cylinder rim.

9. The gas pressure spring according to claim 1, wherein a distance of the compensating cylinder from the working cylinder measured radially to the stroke axis is greater in the stroke region than in an end region of the working cylinder lying between the stroke region and the open end of the working cylinder.

10. The gas pressure spring according to claim 9, wherein an end region outer diameter of the working cylinder measured radially to the stroke axis is larger than a stroke region outer diameter of the working cylinder in the stroke region measured radially to the stroke axis.

11. The gas pressure spring according to claim 9, wherein the stroke region and the end region of the working cylinder are integrally connected to one another.

12. The gas pressure spring according to claim 1, wherein the working cylinder in a sealing region between the stroke region and a piston rod end of the working cylinder opposite the open end along the stroke axis, at which a piston rod attached to the working piston emerges from the working cylinder, has a sealing region outer diameter measured radially to the stroke axis which is larger than the stroke region outer diameter of the working cylinder.

13. A method for producing the gas pressure spring according to claim 1, further comprising forming or machining a compensating piston blank into the compensating piston.

14. The method according to claim 13, further comprising the steps of:
providing a working cylinder blank, wherein the working cylinder blank is shaped as a hollow cylinder and has an outer diameter transverse to the longitudinal axis that is independent from a position along its longitudinal axis, and
forming the working cylinder blank into the working cylinder of the gas pressure spring,
wherein the forming comprises widening the outer diameter of the working cylinder blank in at least one end region of the working cylinder blank.

15. The method according to claim 14, wherein the expansion comprises inserting a mandrel into the at least one end region and arranging a sleeve running around the longitudinal axis around the end region before inserting the mandrel, so that the end region rests against the sleeve after expansion.
